(19) United States
(12) Patent Application Publication
(10) Pub. No.: US 2012/0091123 A1
(43) Pub. Date: Apr. 19, 2012

(54) MICROWAVE SYSTEM AND METHOD FOR CONTROLLING THE STERILIZATION AND INFESTATION OF CROP SOILS

(76) Inventor: William Thomas Joines, Durham, NC (US)

(21) Appl. No.: 13/338,107

(22) Filed: Dec. 27, 2011

Related U.S. Application Data
(63) Continuation-in-part of application No. 12/471,173, filed on May 22, 2009.
Application No. 12/471,173 is a continuation of application No. 11/329,629, filed on Jan. 11, 2006, now Pat. No. 7,601,936.
(60) Provisional application No. 60/643,015, filed on Jan. 11, 2005.

(51) Int. Cl. H05B 6/80; H05B 6/64; H05B 6/70

(52) U.S. Cl. 219/690

(57) ABSTRACT

The method and the system are applicable in farming activities, pest control, industry, agriculture, forestry, etc. for controlling insects and other plant pests from crops. The system performing the method comprises a source of lethal impact which is a microwave generator with a microwave guiding element directed so as to infested soil. The microwave energy is transferred from a microwave generator into the pests located in the desired soil location, killing the plant insects and pests.

### PRIORITY

This application is a continuation of, and claims priority from co-pending, commonly owned non-provisional application Ser. No. 12/471,173 filed May 22, 2009, which claims the benefit of priority to application Ser. No. 11/329,629 (now U.S. Pat. No. 7,601,936), filed Jan. 11, 2006, which claims the benefit of provisional application Ser. No. 60/643,015, filed Jan. 11, 2005, the entire contents of each of the above are incorporated herein by reference.

### FIELD OF INVENTION

Embodiments of the present invention relates generally to microwave antennas, sources and leakage protection mechanisms, and more specifically to a directed-energy microwave system for irradiating crop soils to control infestation.

### BACKGROUND

The world's food supply is being greatly diminished because of infestation of fruit and vegetable plants by insects that attack the root system within the soil. The problem is partially controlled by the fumigation of chemical pesticides into the soil after harvest and before planting. However, a potentially more serious problem is created by the accumulation of chemical pesticides in the soil. The pesticides will eventually filter down to the water table, and run-off will occur during rains or irrigation. This diminishes the purity of the water we use for drinking, cooking and bathing. Also, workers applying the pesticides are subjected to a degree of risk to their short-term and long-term health.

Therefore, there is a continuing and unaddressed need in the art for sterilization for crop soil without the use of harmful pesticides.

### SUMMARY OF THE INVENTION

Embodiments of the present invention relates to a microwave source system for controlling the sterilization of infestation of crop soil.

Embodiments of the present invention replace the chemical pesticide system with a directed energy system that leaves no residual pollutants in the soil after the energy source is switched off.

Embodiments of the present invention use a portable microwave generator that is connected to an applicator that transfers microwave energy from the portable generator into the soil along the rows that will be used for planting. Both the generator and applicator may be mounted on a vehicle that moves over the tops of the rows. An amount of microwave energy is transferred into the soil to be absorbed within the insects or other objects in the soil or by the soil itself. The system may include leakage suppressors that keep the microwave energy directed into the soil and not into the surrounding environment.

Embodiments of the present invention are directed to a system. The system include an applicator connected to a generator to transfer outputted electromagnetic energy from the generator into a section of land. The applicator includes a housing having a shape to substantially conform to the shape created by a soil crop row and ground surrounding the soil crop row. The applicator may also include a portion for receiving the electromagnetic energy outputted from the generator to the applicator. The applicator is configured to transfer at least a portion of the outputted electromagnetic energy into the section of the land.

Other embodiments are directed to a method of directing microwave energy into soil. The method may include activating a microwave generator that is mounted on a vehicle and connected to an applicator that conforms to the topography of a soil crop row. The method may further include operating said vehicle so as to transfer at least a portion of the outputted microwave energy from said microwave generator into the soil. The applicator may include at least one leakage suppressor.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 shows an application of some embodiments of the present invention where the microwave system is attached to a vehicle.

FIG. 2 is a perspective view of some embodiments of the present invention positioned so as to focus on the soil shown.

FIG. 3 is a perspective view of a cross section of the present invention. This application is not connected to a microwave source.

FIG. 4 is a planar cross-sectional view of an application of the present invention with an operating frequency of 915 MHz. This system is shown connected to a microwave source. The microwave system is positioned so as to focus on the soil shown.

FIG. 5 is a perspective cross-sectional view of an application of the present invention illustrating a roller system in the applicator in accordance with some embodiments of the present invention.

FIG. 6 is a cross-sectional view of an applicator that evenly distributes microwave energy to a soil crop row in accordance with some embodiments of the present invention.

### DETAILED DESCRIPTION OF THE INVENTION

Embodiments of the present invention relates to a microwave apparatus designed to control the infestation of harmful insects, worms, bacteria and anything else harmful to crops or plants. Other advantages are also realized.

As used herein, “soil” may include the soil and, optionally, living organisms in the ground that are harmful to plants (e.g insects).

As used herein, “insects” may refer to any living organism capable of being located in or on soil. The definition, as used herein, is not limited to the typical meaning of an insect, but to other creatures, such as worms, bacteria, and other creatures of harm to plants or that feed off of plants and/or other objects in or on soil.

As used herein, “vehicle” refers to any apparatus that has a portion that may be operated or placed in motion.

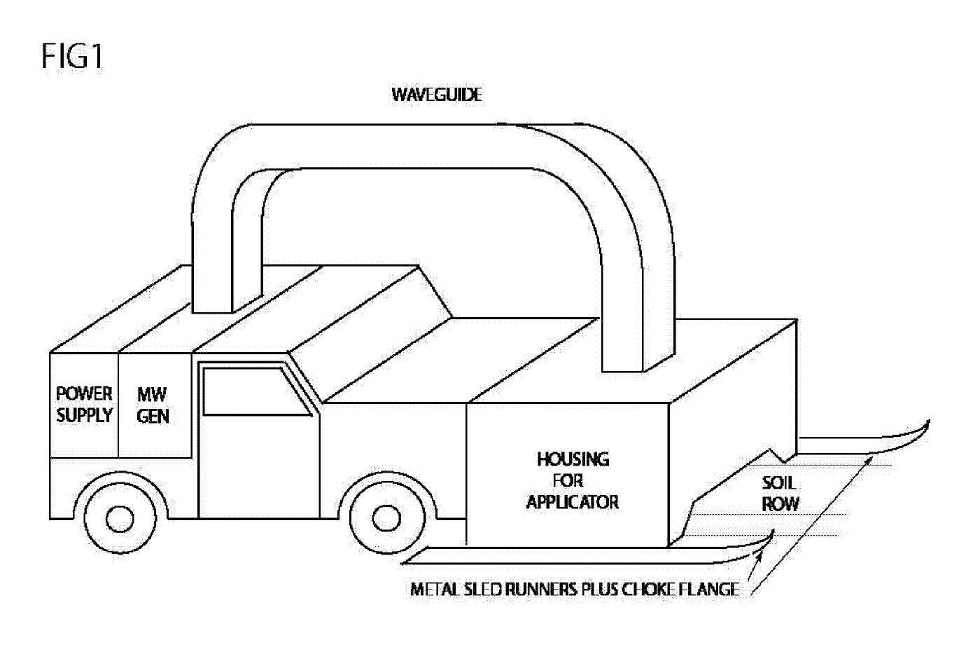

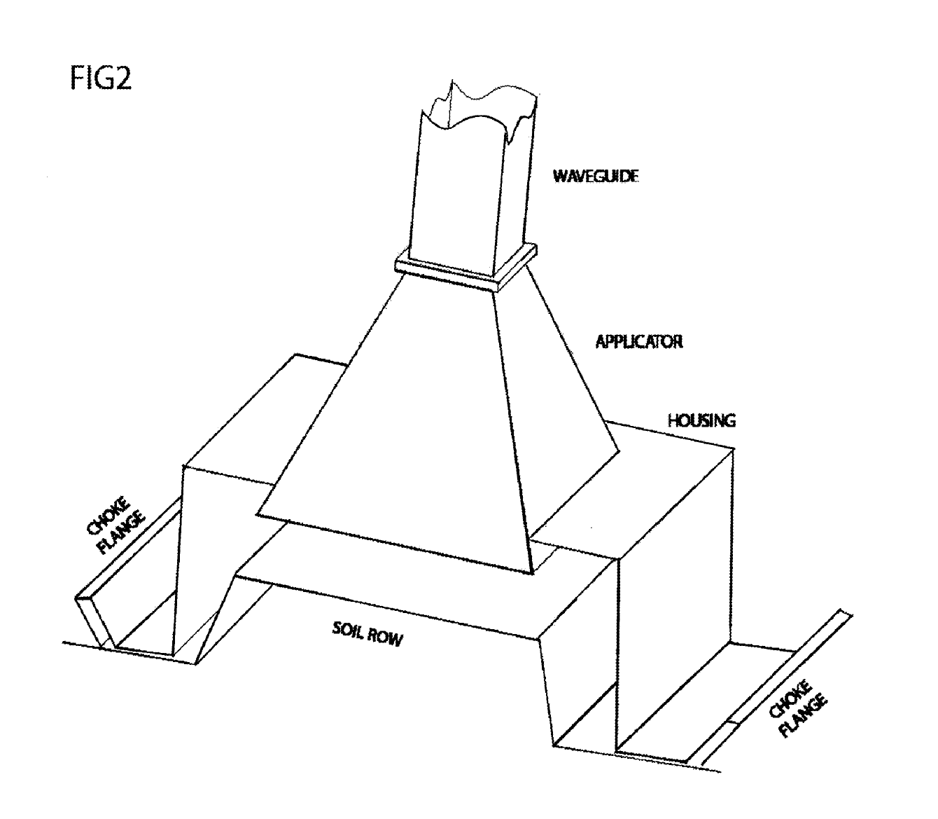

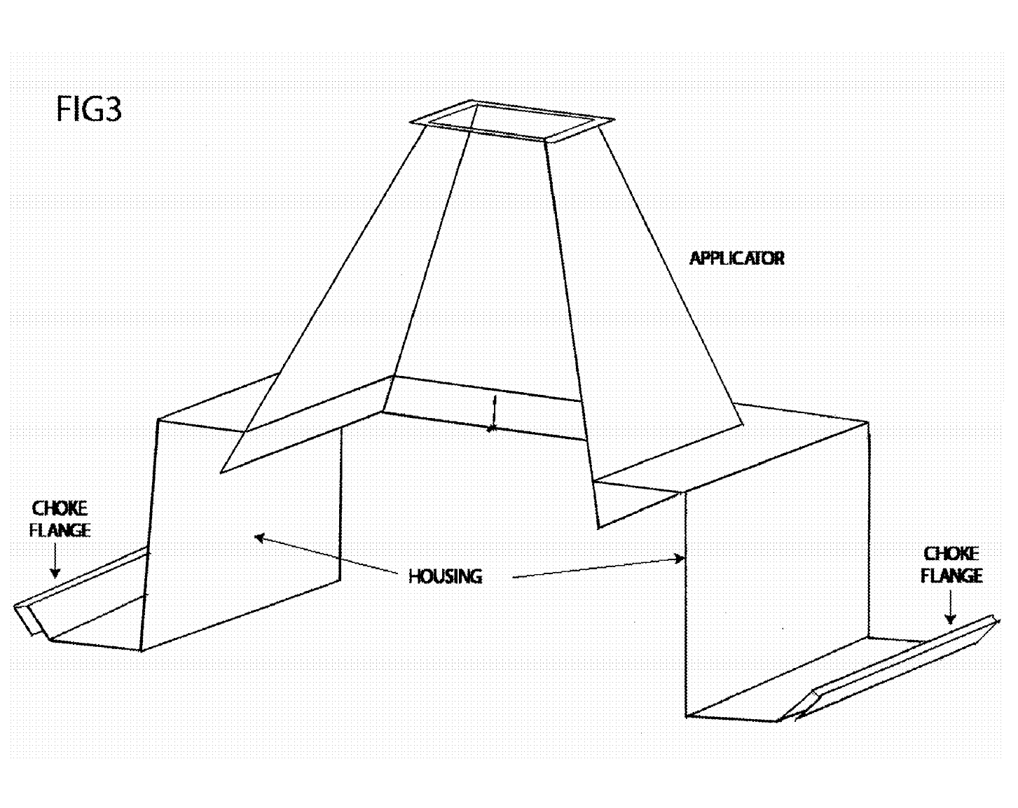

FIGS. 1-5 shows one embodiment of the invention of a system to be used on, for example, crop soil that has been prepared for planting. As illustrated, the system includes a microwave generator and an applicator. The applicator includes a sidewall having an edge proximate to the ground, where an applicator edge is adapted to be arranged transversely to a soil crop row. The dimensions and arrangement of individual parts of the applicator may be constructed to conform to the crop row dimensions. For example, a sidewall edge of the applicator may have a non-linear shape, such as an inverted “U” shape, so as to receive the soil crop row. However, the applicator may be configured to receive soil crop rows having any shape. For example, the crop rows may have raised and flat-topped rows, as illustrated in the Figures. These raised and flat-topped rows may be approximately 8 inches tall and 34 inches wide at the base and the applicator be configured to received these crop rows. It should be understood that the distance from the edge of the applicator to the ground is equal all around the application, while over the soil crop row.

The dimensions and arrangement of individual parts of the applicator may be constructed to distribute the microwave energy over the width of the row (and/or other areas) while preventing energy leakage into the outside environment via at least one microwave leakage suppressor. A portable microwave generator has at least one waveguide or transmission line connected between the generator and the applicator to direct outputted electromagnetic energy (e.g., microwave energy) through the applicator and into the soil. It will be appreciated by those skilled in the art that a wide variety of microwave generators, waveguides and/or transmission lines may be used in conjunction with the present invention.

The generator has an output port to output microwave energy to an input port of the applicator via the waveguide or other device. However, it should be understood that other configurations may be possible, such as connecting the input port of the applicator directly to the output port of the portable microwave generator.

The shape of the waveguide may be configured to guide the microwave transmission into infested soil. The shape of the waveguide, with respect to the microwave power and frequency, may be such that the ray paths of the microwave energy would enter the ground at an angle substantially perpendicular to the soil. This minimizes reflections from the ground causing a maximization of electromagnetic energy into the soil and thus into the pests and insects located within the soil.

An embodiment of the invention includes at least one metal slat or “sled runner.” The metal slats may be made of a microwave reflective material, such as any conductive material. The metal slats may stay in contact with the soil on each side of the crop row to prevent the loss of energy into the environment, thus maintaining the efficiency and safety of the invention. These metal slats may be used with different applicators and leakage suppression structures, sled runners and wheels, parabolic reflectors, corner reflectors, horns with no cowl and the like.

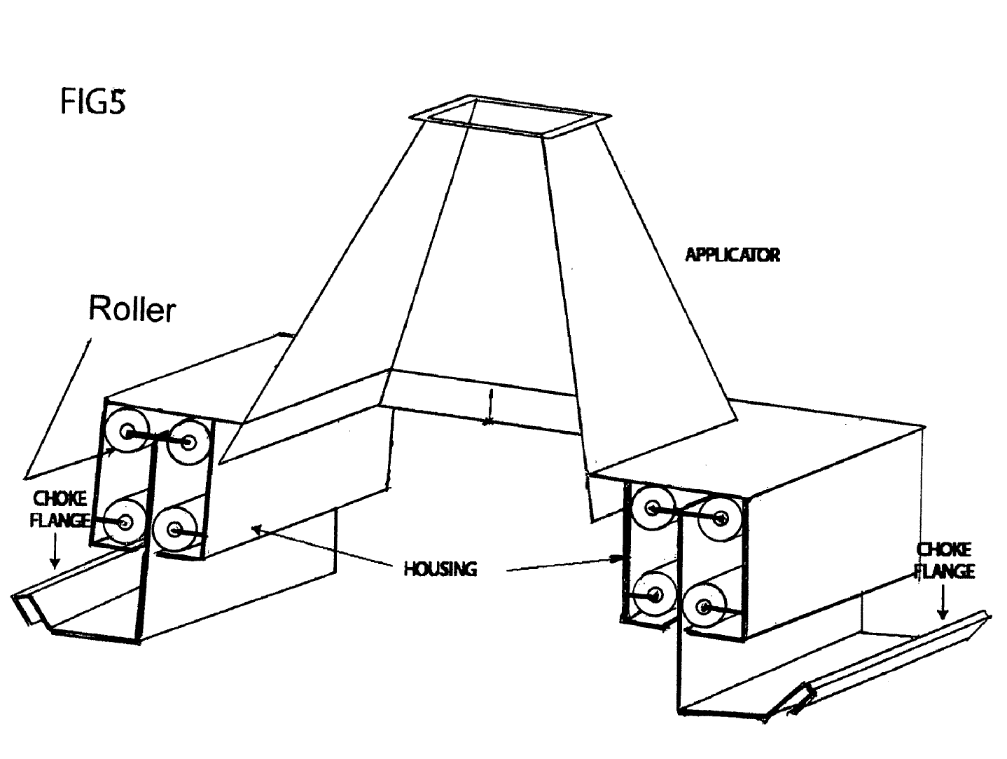

The applicator may include a roller system which includes rollers at the end of the metal slats, as illustrated in FIG. 5. The rollers make continuous electrical contact with the applicator and also with the metal slats and thus the leakage suppressors. The roller system allows for the metal slats to contract into the applicator and extend away from the applicator. Since the metal slats make contact with the soil, the roller system allows the metal slats to stay close to the soil, instead of bouncing (e.g., not staying a consistent distance from the soil), while the vehicle is in motion, especially when vehicle travels over bumps, crop rows or any other section of the land where there may be substantial changes in topography.

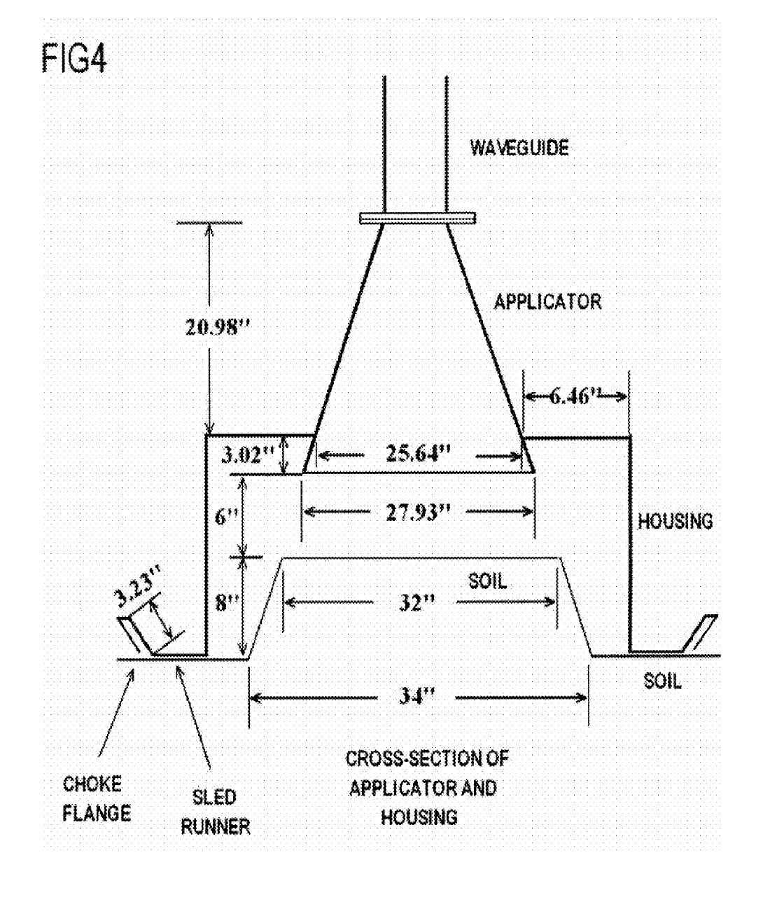

In addition to metal slats or sled runners, leakage suppressors or “choke flanges” may be placed at the end of the applicator or metal slats in order to suppress microwave leakage and/or radiation. The leakage suppressors or choke flanges are generally a quarter-wavelength in length, as indicated by the 3.23-inch length in FIG. 4 for use at 915 MHz.

In one embodiment, each leakage suppressor may have an “L”-shaped unitary member. The leakage suppressor may include a first portion and a second portion, where the second portion extends from a distal end of the first portion in a direction away from an internal space defined by the applicator and ground located directly underneath the applicator. In one embodiment, a plurality of metal slats may be employed. The first portion of the metal slats include a planar sheet of metal extending perpendicular to the ground and extending lengthwise along one side of the applicator. The second portion has a planar sheet of metal connected perpendicularly to the first portion and extends substantially parallel to a section of ground in a direction away from the input port. The second portion may be the only portion of said applicator that makes direct microwave contact with the ground. The length of the second portion is substantially a quarter-wavelength long.

The power of microwave signals propagating through soil is attenuated with respect to distance (z) into the soil as,

P(z)=P₀e^{-2z/δ} (1)

where

$$δ = \frac{\sqrt{{ɛ}_{s}}}{( 60 {πσ}_{s} )} \qquad ( 2 )$$

is the so-called depth of penetration, εₛ is the relative dielectric constant of the soil (usually ranging from 4 to 7), σₛ is the conductivity of the soil (usually less than 0.025 S/m) and P₀ is the power in watts per square meter entering the soil surface at z=0. Equation (2) is valid for determining δ if σₛ≦0.0056f_{G} εₛ, where f_{G} is the microwave frequency in GHz. Thus, for εₛ=5 and f_{G}=0.915, (2) is valid for all σₛ≦0.025 S/m, the usual range for soil conductivity, and for these parameter values δ≧0.475 m=1.56 ft. Designating the soil as damp (σₛ=0.025 S/m), normal (σₛ=0.015 S/m) and dry (σₛ=0.005 S/m), the corresponding depths of penetration are, respectively: 1.56 ft, 2.60 ft and 7.80 ft at 915 MHz or fG=0.915.

When heating insects at a particular depth within the soil, the microwave energy must pass through the soil to reach the insects at that depth. The equation used to make this calculation assumes that the target insect is small compared with wavelength. For example, at 0.915 GHz (915 MHz) the wavelength in soil is approximately 0.15 m=150 mm, and the target insects are typically less than few millimeters in diameter. Thus, the power absorbed in watts per cubic meter by an insect at any depth z includes equation (1) and is expressed as [1]:

$${P}_{a} ( z ) = \frac{9 {σ}_{i} ( 120 π / \sqrt{{ɛ}_{s}} ) {P}_{0} {e}^{- 2 z / δ}}{{( \frac{{ɛ}_{i}}{{ɛ}_{s}} + 2 )}^{2} + {( \frac{18 {σ}_{i}}{{f}_{G} {ɛ}_{s}} )}^{2}} \qquad ( 3 )$$

For example, if P₀=100 kW/m², f_{G}=0.915, σᵢ=3 S/m, εᵢ=49, sigma_s=0.015 S/m and varepsilon_s=5, then:

Pₐ(z)=1.599×10⁶e^{-2z/δ} W/m³=1.599e^{-2z/δ} W/cm³ (4)

where the subscript, s, refers to the soil properties, and the subscript, i, refers to insect properties.

It may be assumed that the moisture within the insect is heated by the absorption of microwave energy. Using the fact that 1 calorie of energy will increase the temperature of 1 gram of water by 1° C., the initial rate of temperature increase in the insect is determined by:

Pₐ=KρcdT/dt=4.186 joules/cal×1 gm/cc×1 cal/(gm° C.)(° C./sec)=W/cm³ (5)

### Thus,

dT/dt=(1.599/4.186)e^{-2z/δ}° C./sec=0.382e^{-2z/δ}° C./sec (6)

For dry soil conditions, the initial rate of temperature increase within an insect at various depths within the soil is determined from (6) as: z=0, dT/dt=0.382° C./sec=60.38° C./min; z=0.25δ=1.95 ft, dT/dt=0.232° C./sec=13.92° C./min; z=0.5δ=3.90 ft, dT/dt=0.141° C./sec=8.46° C./min and z=δ=7.8 ft, dT/dt=0.052° C./sec=3.12° C./min.

The above applications of the instant invention have been used at 915 MHz. This invention is not limited to this frequency. This invention, including dimensions, microwave source and other relevant parameters, may be modified to a frequency lower than 915 Mhz in order to obtain a greater depth of penetration into the soil. Conversely, the operational microwave frequency may be increased, e.g. 2.45 GHz, in order to increase the concentration of microwave energy into the uppermost layer of the soil.

### Uniform Distribution of Power

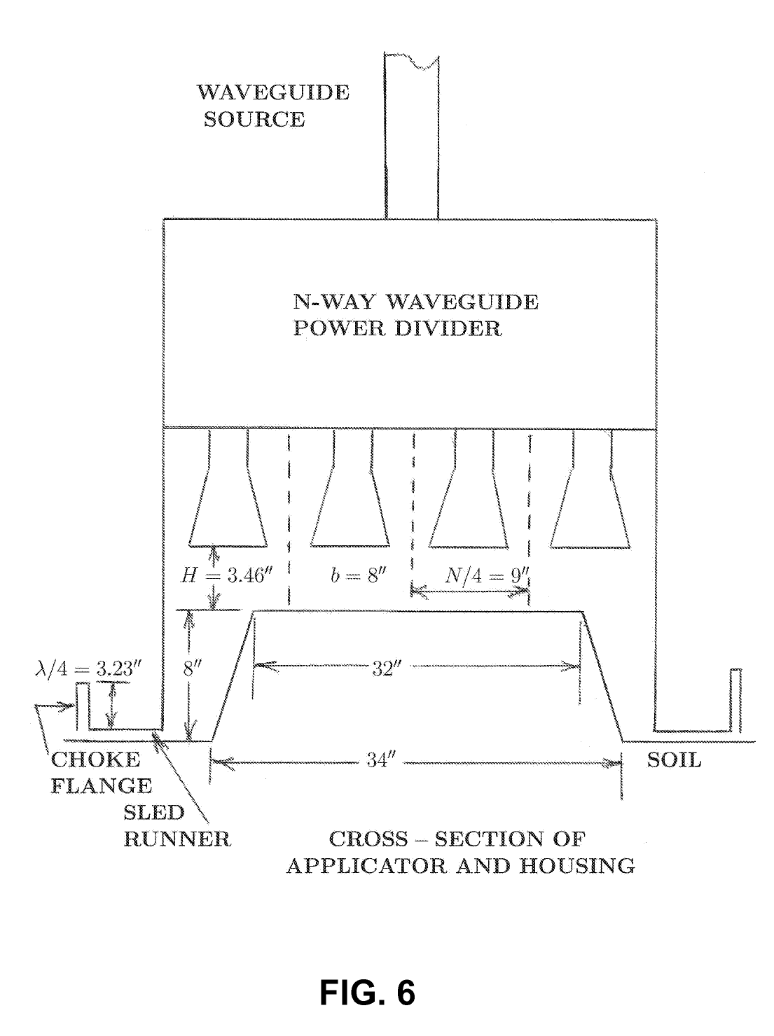

In another embodiment, in order to distribute the microwave energy substantially evenly (e.g., not more concentrated in the center of the soil row), two possibilities are provided. FIG. 6 provides an exemplary illustration. The first solution (“Solution 1”), in one embodiment, may be to provide a 100,000 watt microwave generator operating at 915 MHz frequency that distributes the microwave source power as will be described later. The second solution (“Solution 2”), in one embodiment, is to use an array of individual 1300 watt microwave sources operating at 2450 MHz and distribute the 115-volt, 60 Hertz AC power to the individual microwave sources as described below.

Solution 1 is to divide the source energy into N equal parts by using standard waveguide N-way power dividers, as illustrated in FIG. 6. The power would be received from the microwave generator and then after entering the applicator would be divided equally using the N-way power dividers. If a certain amount (“N”) of antennas or waveguide applicators is spaced equally across the width of the soil row within the applicator region, such as 36 inches, then each horn waveguide applicator is placed at the center of each 36/N-inch segment of the 36-inch width of the soil row. Thus, if N=4, then each horn waveguide applicator would be placed at the center of each 9-inch segment across the soil row so that a single soil crop row would have four evenly spaced waveguides applying microwave energy thereto in a substantially even fashion as compared without such waveguides. Also, each horn waveguide applicator emits microwave energy in a beam that has maximum power directly in front of the applicator, and the magnitude of this energy or power decreases in a known way as one moves to the left or right across the soil row away from the maximum power point in front of the applicator. The half-power points on either side of the maximum power point;

$$BW ( in degrees ) = \frac{65 \times λ}{b} \qquad ( 7 )$$

where λ=c/f is wavelength of the applied microwave energy (f is the microwave frequency and c=3×10⁸ m/s=11.81×10⁹ inches/s in air), and b is the width of the waveguide opening or horn applicator within the 9-inch segment of the soil row. The microwave power entering the soil can be made approximately uniform by requiring adjacent half-power points to overlap and be located at the soil surface. Thus, the distance H in inches from the front surface of the applicator to the surface of the soil is:

$$H = \frac{36}{2 N tan ( BW / 2 )} \qquad ( 8 )$$

or, substituting (7) into (8) yields,

$$H = \frac{36}{2 N tan ( \frac{65 \times λ}{2 b} )} = \frac{36}{2 N tan ( \frac{32.5 \times λ}{b} )} \qquad ( 9 )$$

As an example of Solution 1, if WR975 (9.75″×4.875″) rectangular waveguides are used for N=4 applicators, each within 9-inch segments across the soil row, then at an operating frequency of 915 MHz, the wavelength is λ=12.907 inches, and the height H above the soil surface is,

$$\begin{matrix}H = \frac{36}{8 tan ( \frac{32.5 \times 12.907}{b} )} \\ = \frac{36}{tan ( \frac{419.48}{b} )} \\ = {3.46}^{″}\end{matrix}$$

$$for b = {8}^{″} , \\ {2.6}^{″} for b = {7}^{″} , {1.65}^{″} for b = {6}^{″}$$

where the short side (4.875″) of the WR975 waveguide is tapered to become the desired value of b used in the foregoing equations. The side b is aligned with the width of the soil row, and the long side (9.75″) is aligned with the length of the soil row. To yield adequate clearance between the front surface of the applicator and the top surface of the soil, a reasonable choice is to make b=8 inches which makes H=3.46 inches. This example application is diagramed in FIG. 6. Note that the top flat part of the soil row is 32 inches wide, and the tapered sides increase the width to 34 inches. In this embodiment, the soil row is 36 inches wide to ensure adequate coverage by the microwave energy.

An example of Solution 2 is to construct identical 1300-watt microwave sources, using many of the same components found in 1300-watt, 2450 MHz microwave ovens. To put at least 100 kW of microwave power into the soil (as in Solution 1), these sources would be arranged in an array across and along the soil row, as 9×9×1300=105 kW, 8×10×1300=104 kW, 7×12×1300=109 kW, 6×13×1300=101 kW, 5×14×1300=104 kW or 4×20×1300=104 kW. At 2450 MHz, the standard waveguide (WR340) is 3.4 by 1.7 inches, and the wavelength is 4.82 inches. The 1.7 dimension would be tapered up to 3.4 inches, so that the radiating aperture of each applicator would be 3.4 by 3.4 inches and fitted to each individual source in the array. Using (7), (8) and (9), with b=3.4 inches, we determine H to make the power uniform at the soil surface, as: H=1.93″ for the 9 by 9 array (9 across and 9 along the row); H=2.17″ for the 8 by 10 array (8 across the row, 10 along the row); H=2.48″ for the 7 by 12 array (7 across and 12 along), H=2.89″ for the 6×13 array; H=3.47″ for the 5×14 array and H=4.34″ for the 4×20 array. The 4×20 array would appear similar in cross-section to FIG. 1, except individual 1.3 kW sources feed the waveguide horns (no waveguide power divider), and the H and b dimensions would change to H=4.34 inches and b=3.4 inches. To complete the 4×20 array, there would be 19 more rows of 4 spaced along the length of the soil row. Also, the lambda/4 choke flange length would change from 3.23 inches 4.82/lambda=1.205 inches at 2450 MHz.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A microwave system comprising:
a microwave generator capable of outputting microwave energy and comprising a first output port;
a contacting system which makes continuous electrical contact with the at least one microwave leakage suppressor and the applicator housing while the vehicle is in motion so that the at least one microwave leakage suppressor is capable of free movement within the contacting system;
a first waveguide to receive microwave energy from the first output port of the microwave generator and to output microwave energy to an output port of the first waveguide;
an applicator connected with the output port of the first waveguide and having a shape configured to receive a soil crop row and comprising:
a waveguide power divider to divide the microwave energy N-ways and equally from the output port of the first waveguide;
a second waveguide to receive a first divided power divided from the waveguide power divider and to transfer the first divided power to the soil crop row; and
a third waveguide to receive a second divided power divided from the waveguide power divider and to transfer the second divided power to the soil crop row;
wherein the second and third waveguides are oriented so that microwave energy is substantially evenly distributed into the soil crop row.

2. The microwave system of claim 1, wherein the applicator and the generator are mounted on a vehicle.

3. The microwave system of claim 1, wherein said contacting system comprises at least two rollers, a metallic means that connects said at least two rollers to the applicator, wherein the contacting system allows the at least one microwave leakage suppressor to contract and expand relative to the applicator housing while the vehicle is in motion in order to compensate for changes in soil topography.

4. The microwave system of claim 1, wherein the second and third waveguides are orientated so that the microwave energy travels to the soil approximately perpendicular to the soil.

5. The microwave system of claim 4, wherein the shape of the second and third waveguides are horn waveguides.

6. The microwave system of claim 1, wherein said microwave generator operates at a frequency of 915 Megahertz.

7. The microwave system of claim 1, wherein said outputted microwave energy is sufficient to kill insects living in said section of land.

8. The microwave system of claim 1, wherein said applicator comprises a sidewall having an edge proximate to the ground, said edge adapted to be arranged transversely to said soil crop row and said sidewall edge having a non-linear shape so as to receive said soil crop row.

9. The microwave system of claim 8, wherein said edge comprises at least an edge portion having an inverted “U” shape for receiving said soil crop row.

10. The microwave system of claim 1, wherein said at least one leakage suppressor comprises an “L”-shaped unitary member and wherein a portion of said at least one leakage suppressor comprises a first portion and a second portion, the second portion extending from a distal end of said first portion in a direction away from an internal space defined by said applicator and ground located directly underneath said applicator.

11. The microwave system of claim 10, wherein said first portion comprises a planar sheet of metal extending perpendicular to the ground and extending lengthwise along one side of said applicator, and said second portion comprises another planar sheet of metal connected perpendicularly to said first portion and extending substantially parallel said section of ground in a direction away from said input port, wherein said second portion is the only portion of said applicator that makes direct contact with the ground.

12. A method of directing microwave energy into soil comprising:
activating a microwave generator that is mounted on a vehicle and connected to an applicator that conforms to the topography of a soil crop row; and
operating said vehicle so as to transfer at least a portion of the outputted microwave energy from said microwave generator into the soil by:
transferring microwave energy from the microwave generator to a waveguide feeding into the applicator;
dividing the microwave energy in the applicator into at least two waveguides,
wherein the at least two waveguides are spaced within the applicator to evenly distribute the microwave energy to the soil, and
wherein said applicator comprises at least one leakage suppressor.

13. The method of claim 12, wherein said vehicle is continuously operated to direct microwave energy over a continuous strip of soil.

14. The method of claim 12, wherein said directed microwave energy is sufficient to kill insects living in said soil.

15. The method of claim 14, wherein a frequency of said microwave generator is 915 Megahertz.

16. A system comprising:
a first waveguide to receive microwave energy from a first output port of a microwave generator and to output microwave energy to an output port of the first waveguide;
an applicator connected with the output port of the first waveguide and configured to transfer microwave energy into a section of land, the applicator comprising:
a waveguide power divider to divide the microwave energy from the output port of the first waveguide;
a second waveguide to receive a first divided power divided from the waveguide power divider and to transfer the first divided power to the section of land; and
a third waveguide to receive a second divided power divided from the waveguide power divider and to transfer the second divided power to the section of land;
wherein the second and third waveguides are oriented so that microwave energy is substantially evenly distributed into the soil crop row,

17. The system of claim 16, further comprising a vehicle, the applicator being connected to the vehicle.

18. The system of claim 16, further comprising at least one electromagnetic leakage suppressor so that electromagnetic energy that is not absorbed by the section of land is not leaked into an exterior of the applicator.

19. The system of claim 16, further comprising a microwave generator attached to the applicator.
